(19) United States
(12) Patent Application Publication
(10) Pub. No.: US 2025/0011514 A1
(43) Pub. Date: Jan. 9, 2025

(54) MIKTOARM STAR POLYMER AS CEMENT FLUID ADDITIVES

(71) Applicant: SOLENIS TECHNOLOGIES, L.P., Wilmington, DE (US)

(72) Inventors: Leo Zhaoqing Liu, Newark, DE (US); Yanrong Lu, Newark, DE (US)

(73) Assignee: SOLENIS TECHNOLOGIES, L.P., Wilmington, DE (US)

(21) Appl. No.: 18/762,778

(22) Filed: Jul. 3, 2024

Related U.S. Application Data
(60) Provisional application No. 63/511,898, filed on Jul. 5, 2023.

(51) Int. Cl. C08F 228/02; C04B 16/04; C04B 103/00; C04B 103/32; C04B 103/40

(52) U.S. Cl. CPC C08F 228/02; C04B 16/04; C04B 2103/0061; C04B 2103/32; C04B 2103/408

(57) ABSTRACT

Provided is Miktoarm star polymers, which are provided either as an aqueous solution or as thin micro-flakes. Also provided is a process of making the star polymers thereof. These polymers bear short polyacrylic segment(s) and long buoyant sulfonated polymer segment(s), which were found to be effective as additives for cement slurry water retention and as a plasticizer.

### CROSS REFERENCE TO RELATED APPLICATIONS

This application claims the benefit of U.S. Provisional application No. 63/511,898, filed 5 Jul. 2023, the entire contents of which are hereby incorporated by reference.

### TECHNICAL FIELD

The present disclosure generally relates to a miktoarm star (μ-star) polymer, the process of making the star polymer and use of the star polymer in mortar or concrete applications and processes.

### BACKGROUND

Water retention in cement grouts or mortar systems are critical for the settled material strength and permeability. Water could be lost from mortar system as a result of negative capillary forces. In the exploration of oil and gas, cement slurry is used to seal oil and gas well. However, water could be filtered out from cement slurry under the high hydrostatic pressure of the cementing column and the hot temperature surrounding the formation.

Various additives are used in mortar grouts or cement slurry such as defoamers, dispersants, plasticizers, retardants as well as water retention or fluid loss control agents. However, these additives can interact with mortar or cement as well as with each other in undesirable ways. For example, dispersants or retardants can adversely affect the fluid loss control agents, making the latter less effective. On the other hand, some of the fluid loss control agents rely on the thickening effect caused by interstitial water of the slurry or mortar from added polymeric materials such as polysaccharides and other synthetic polymers. The use of such polymeric fluid loss control agents may be limited by high solid volume fraction of cement slurry, which is often higher than 50% for high demand applications. Therefore, there is still a demand and need for a fluid loss control agent with little or no negative affect as mentioned above. It is desirable that single additives have multiple functions. For example, a water retention or fluid loss control agent for cement could also serve as a dispersant or superplasticizer, thus limiting the cost of use and environment impacts.

To enhance the interaction of water retention or fluid loss control agent with the substrate without negative impact from other additives in the compositions or without thickening the substrate have been tried, such as using a divinyl ether cross-linked microgel with limited success. Such fluid loss control agents still thickens mortar systems and cement slurries. Di-block polymers as fluid loss control has been tried using a first shorter chain polymer block bonding to the substrate particles and a second longer chain polymer block that extends out into the fluid surrounding the particles, thus creating hairy cement particles.

Such products were shown to have efficacy as fluid loss control agent for a particular type of well cementing. However, the production of the di-block polymer utilized large amounts of organic solvent for its first short chain block, and it takes more than a day to produce the product. Therefore, there is still a need to have a more economic fluid loss control product but with higher efficacy or dual or even multiple functions.

Polymers with precisely controlled structure and function are in high demand across a diverse array of applications. One prototypical example is a class of branched block copolymers known as miktoarm stars (μ-stars) polymers. Miktoarm star (μ-star) polymers are those comprising two or more arm compositions, arm topologies, arm molecular weights (MWs), and/or arm chain end functionalities connected at a common junction. They have been obtained through various methods (M. Liu et al Chem. Mater. 2022, 34, 6188-6290; H. Iatrou et al Polymer Chemistry Series No 25, Miktoarm Star Polymers: from Basics of Branched Arckitecture to Synthesis, Self-assembly and Applications). However, such polymers have limited industrial applications due to the expensive organic solvent processes which are not environmentally friendly.

Miktoarm star (μ-star) polymers are usually formed by using either multifunctional initiators, multifunctional chain transfer agents, or multifunctional coupling agents. In comparison with linear polymers, the star-branched polymers have unique properties including narrow molecular weight distributions; low viscosities at low molecular weights either in liquid form or in solution due to their compact structures; high viscosities at high molecular weights due to extensive entanglements.

### BRIEF SUMMARY

Provided is a water-borne miktoarm star polymer composition that includes one or more distinct polymer chain(s) or segment(s) bearing one or more of functional monomeric unit chosen from carboxylic acid, phosphate acid ester, and phosphonate; hydrophilic polymer chain(s) or segment(s) bearing one or more of the functional monomeric unit chosen from sulfonate and sulfate, and combinations thereof. The one or more distinct polymer chain(s) or segment(s) and the one or more hydrophilic polymer chain(s) or segment(s) form the arms of the star polymer diverging from a moiety bearing polyfunctional radical transfer functions chosen from thiol or mercaptan functional groups, phosphinic acid, phosphites, and combinations thereof.

Also provided is a process of producing a miktoarm star polymer that includes preparing a thiol-bearing telechelic polymer chain by polymerizing a composition comprising monomers bearing carboxylic acids, phosphate acid esters, phosphonates, and combinations thereof with a polythiol or mercaptan-bearing moiety and a radical initiator.

A monomer solution is then prepared using one or more monomer bearing sulfonate or sulfate functional groups for forming one or more hydrophilic polymer chain(s) or segment(s). The one or more thiol-bearing telechelic polymer chain from above is combined with the monomer solution and initiating polymerization via radical initiator(s). The polymerization reaction is continued until the thiol concentration is non-detectable by using Ellman assay techniques thereby producing a miktoarm star polymer diverging from a moiety bearing polyfunctional radical transfer functions. The moiety can be from thiol or mercaptan functional groups, phosphinic acid, phosphites, or any combinations thereof.

In addition, provided is a method for reducing fluid loss in mortar or concrete processes that includes providing a mortar ground or concrete slurry and adding to the mortar ground or concrete slurry a water-borne miktoarm star polymer that includes one or more distinct polymer chain bearing one or more of functional monomeric unit that can be from carboxylic acid, phosphate acid ester, and phosphonate and one or more hydrophilic polymer chain bearing one or more functional monomeric unit chosen from sulfonate and sulfate and combinations thereof.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

Provided is a water-borne miktoarm star polymer, also referred to as a star polymer, which includes one or more distinct polymer chain(s) or segment(s) bearing one or more of a functional monomeric unit chosen from carboxylic acid, phosphate acid ester, and phosphonate. The star polymer also includes one or more hydrophilic polymer chain(s) or segment(s) bearing one or more of the functional monomeric units chosen from sulfonate and sulfate, or a combination thereof. Such μ-star polymer could be made through either divergent or convergent methods described in the literature.

The one or more distinct polymer chain(s) or segment(s) and the one or more hydrophilic polymer chain(s) or segment(s) form a miktoarm star polymer diverging from a moiety bearing polyfunctional radical transfer functions chosen from thiol or mercaptan functional groups, phosphinic acid, phosphites, and combinations thereof. The terms, arm(s), chain(s), and segment(s) are used interchangeably throughout.

In some aspects the star polymer further comprises additional monomeric units different from the monomers of the distinct polymer chain(s) and the one or more hydrophilic polymer chain(s).

In other aspects of the star polymer, the one or more distinct polymer chain(s) and the one or more hydrophilic polymer chain(s) are derived from polythiols bearing three or more thiol or mercaptan functional groups.

In yet other aspects of the star polymer, it is conceivable any hydrolytically stable polythiol can be used in the current composition, such as, a thiol-terminated polyol or polyoxyalkylene glycols disclosed in U.S. Pat. Nos. 3,258,495, 3,278,496 and 6,201,099. It is also envisioned that the polythiols disclosed in US application 2018/0051038 can also be used in the present polymer and process. These references are hereby incorporated into the present application in their entirety.

Polythols formed from polyol and thiol or mercaptan carboxylic acid through ester bond formation can also be used for less demanding applications. It is preferred to have polythiols with multi-reactivity toward radical transfer polymerization as taught by US patent.

Thiol-bearing polycarboxylic acids could be obtained by reacting polymer bearing carboxylic acid anhydride functions, such as commercially available polystyrene-polymaleic anhydride, poly(vinylmethyl ether-co-maleic anhydride) or polysuccinamide, precursor to polyaspartic acid. Those thiol-bearing polycarboxylic acid could be used directly as the short chains or to build more polycarboxylic acid chains for miktoarm polymers.

In some aspects of the star polymer, the polyfunctional radical transfer group is chosen from thiol or mercaptan functional groups, or a combination thereof. One or more of the thiols or mercaptan functional groups is attached to one or more of the distinct polymers either through stepwise radical transfer polymerization or direct chemical reaction with thiol-bearing substances and the rest of the thiol functional groups from the distinct polymer(s) act as chain transfer agents to grow the hydrophilic polymer chain(s), thus forming the miktoarm star copolymer. The distinct polymer chain(s) in this case are generally shorter chains or segments than the hydrophobic chains or segments.

In some aspects of the star polymer, one or more of the distinct polymer chain(s) comprises polyacrylic acid arm(s) having a weight average molecular weight of from about 1000 to about 50000 Daltons and one or more of the hydrophilic polymer chain(s) comprises sulfonated or sulfated arm(s) having a weight average molecular weight of from about 10000 to about 1,000,000 Daltons.

In other aspects of the star polymer, the one or more of the hydrophilic polymer chain(s) comprises one sulfonic acid or sulfate ester-containing monomer or its salt alone or with one or more other monomer.

In some aspects of the star polymer, the sulfonic acid-containing monomer is chosen from 2-acrylamido-2-methylpropanesulfonic acid, vinylsulfonic acid, methallyl sulfonic acid, allylhydroxypropanesulfoinic acid, or the salts thereof, styrene sulfonate, or allyl/vinyl polyoxyethylene sulfate ester salt.

In still other aspects of the star polymer, the additional monomer residue is derived from acrylamide, methyacrylamide, N,N-dimethyl(meth)acrylamide, N—N-diethyl(meth)acrylamide, or isopropyl(meth)acrylamide; N-tert-butylacrylamide, or amides of α, β-ethylenically unsaturated mono- or dicarboxylic acids with diamines having one or more primary or secondary amine group; N,N-diallylamines, or N,N-diallyl-N-alkylamines; esters of α, β-ethylenically unsaturated mono- or dicarboxylic acids with C₂₋₃₀ alkanediols or their alkoxylates; tetrahydrofurfuryl acrylate; N-vinylcaprolactam, N-vinylpyrolidone, N-vinylacetamide, N-vinylformamide, N-methyl-N-vinylacetamide, N-vinylpiperidone, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, vinylpyridine, α, β-ethylenically unsaturated ethers of C₂₋₃₀ alkanediols or their alkoxylates, or any combination thereof.

Also provided is a process of producing a miktoarm star polymer that includes preparing a thiol-bearing telechelic polymer chain by polymerizing a composition comprising monomers bearing carboxylic acids, phosphate acid esters, phosphonates, and combinations thereof with a polythiol or mercaptan-bearing moiety and a radical initiator. A monomer solution is then prepared using one or more monomer bearing sulfonate or sulfate functional group to have hydrophilic polymer segment(s). The thiol-bearing telechelic polymer chain(s) from above is combined with the monomer solution and polymerization initiated via radical initiator(s). The polymerization reaction is continued until the thiol concentration is non-detectable using Ellman assay techniques thereby producing a miktoarm star polymer diverging from a moiety bearing polyfunctional radical transfer functions. The radical transfer functional groups of the moiety can be from thiol or mercaptan, phosphinic acid, phosphites, or any combinations thereof.

In some aspects of the process, the star polymer further comprising additional monomeric units different from those in the thiol-bearing telechelic polymer chain(s) and the hydrophilic polymer chain(s), and wherein the additional monomer unit(s) bears functions other than those of the thiol-bearing telechelic polymer chain(s) and the hydrophilic polymer chain(s).

In some aspects of the process, the polyfunctional radical transfer function is chosen from thiol or mercaptan functional groups, or a combination thereof, and wherein one or more of the thiols or mercaptan functional groups is attached to one or more of the distinct polymer chain(s) either through stepwise radical transfer polymerization or direct chemical reaction with thiol-bearing substances and the rest of the thiol functional groups of the distinct polymer chain(s) act as chain transfer agents to grow the hydrophilic polymer segment(s), thus forming the miktoarm star copolymer.

In other aspects of the process, the one or more but not all of the thiol or mercaptan functional groups is attached to the distinct polymer chain(s) and the remaining thiol functional groups on the distinct polymer chain(s) act as chain transfer agents to grow the one or more hydrophilic polymer chain(s).

In yet other aspects of the process, the one or more distinct polymer chain(s) comprise a polyacrylic acid arm having a molecular weight of from about 1000 to about 50000 and the one or more hydrophilic polymer chain(s) or segment(s) comprise sulfonated arms having a molecular weight of from about 10000 to about 1,000,000.

In still other aspects of the process, the one or more hydrophilic polymer segment(s) is chosen from 2-acrylamido-2-methylpropanesulfonic acid, vinylsulfonic acid, methallyl sulfonic acid, allylhydroxypropanesulfoinic acid, or its salts and allyl polyoxyethylene sulfate ester salt alone or with acrylamide, methacrylamide, N,N-dimethyl(meth)acrylamide, N—N-diethyl(meth)acrylamide, isopropyl(meth)acrylamide; N-tert-butylacrylamide, amides of α, β-ethylenically unsaturated mono- or dicarboxylic acids with diamines having one or more primary or secondary amine group; N,N-diallylamines, and N,N-diallyl-N-alkylamines; esters of α, β-ethylenically unsaturated mono- or dicarboxylic acids with C₂₋₃₀ alkanediols or their alkoxylates; and tetrahydrofurfuryl acrylate; N-vinylcaprolactam, N-vinylpyrolidone, N-vinylacetamide, N-vinylformamide, N-methyl-N-vinylacetamide, N-vinylpiperidone, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, and N-vinyl-7-ethyl-2-caprolactam, vinylpyridine, and α, β-ethylenically unsaturated ethers of C₂₋₃₀ alkanediols or their alkoxylates.

In other aspects of the process, the polymerization reaction is continued until the thiol concentration is non-detectable based on Ellman assay techniques.

Also provided is a method for reducing fluid loss in mortar or concrete processes that includes providing a mortar ground or concrete slurry and adding to the mortar ground or concrete slurry a water-borne miktoarm star polymer that has one or more distinct polymer chain(s) or segment(s) bearing one or more functional monomeric units from carboxylic acids, phosphate acid esters, and phosphonates. The star polymer also contains one or more hydrophilic polymer chain(s) or segment(s) bearing one or more functional monomeric units that can be a sulfonate, sulfate, or combination thereof. The distinct polymer chain(s) and hydrophilic polymer chain(s) form a star polymer diverging from a moiety bearing polyfunctional radical transfer functions, such as from thiol or mercaptan functional groups, phosphinic acids, phosphites, and any combination thereof.

In some aspects of the method, the polyfunctional radical transfer function is chosen from thiol or mercaptan functional groups or a combination thereof, and one or more of the thiols or mercaptan functional groups is attached to one or more of the distinct polymers either through stepwise radical transfer polymerization or direct chemical reaction with thiol-bearing substances and the rest of the thiol functional groups from the one or more distinct polymer chain(s) act as chain transfer agents to grow the hydrophilic polymer chain(s), thus forming the miktoarm star polymer.

In other aspects of the method, the thiol functional group(s) from the one or more distinct polymer chain(s) act as chain transfer agents to grow the hydrophilic polymer chain(s) to form the miktoarm star polymer.

In other aspects of the method, one or more of the hydrophilic polymer chain(s) comprises one sulfonic acid-containing monomer or its salt, alone or with one or more other monomer.

### EXAMPLES

The present disclosure is now illustrated by the following non-limiting examples. It should be noted that various changes and modifications may be applied to the following examples and processes without departing from the scope of this invention, which is defined in the appended claims. Therefore, it should be noted that the following examples should be interpreted as illustrative only and not limiting in any sense.

### Example 1

Preparation of a thiol-bearing telechelic polyacrylic acid was accomplished by combining 110.29 grams (g) of water and 84.13 grams of glacier acrylic acid in a one-liter reactor having a mechanical stirrer, nitrogen inlet and thermal couple. The contents of the reactor were purged for 1 hour and heated to 50° C. At this point, 17 grams of Gabepro™ GPM-800 (a mercaptan-terminated polymer) and 15.6 grams ethanol was added to the reactor followed by 0.08 grams of an Azo initiator (Wako™ V-50) in 4 milliliter (ml) water. Polymerization temperature was kept between about 50 to 55 degrees Celsius (° C.) by cooling. The polymerization reaction was monitored by checking the solid content of the polymer using a moisture balance while maintaining a temperature of 120° C. until constant weight. In addition, thiol concentration was monitored using the Ellman's method. Polymerization was terminated when 48% of thiol was left and acrylic acid reached a conversion of 91%. The sample that was not immediately used was stored in refrigerator in a sealed container under nitrogen for about 1 week to minimize further consumption of thiols. The amount of thiol may go down over 2 weeks from 48 to around 30%, but it is generally stable without any neutralization. Such variations in thiol contents on polyacrylic acid was considered acceptable to make μ-star block co-polymer.

### Example 2

The preparation of the thiol-bearing telechelic polyacrylic acid in this example was similar to that of Example 1, as follows: 145.42 grams (g) of water, 84.17 grams of glacier acrylic acid, and 5.53 grams of 50% caustic soda were added to a one-liter reactor having a mechanical stirrer, nitrogen inlet and thermal couple. The contents of the reactor were purged for 1 hour and heated to 50° C. At this point, 17.8 grams of Gabepro™ GPM-800 (a mercaptan-terminated polymer) and 16.55 grams methanol was added to the reactor was added. Exothermic reaction was observed, the temperature increased to 65° C. After the temperature returned to 50° C., 0.05 grams of an Azo initiator (Wako™ V-50) in 4 milliliter (ml) water was charged to the reactor keeping the polymerization temperature between about 52° C. to 53° C. until 44% total thiol in the reaction mixture was left and the acrylic acid reached 93% conversion according to solid content measurements using a moisture balance at 130° C. Neutralization with caustic soda lead to faster consumption of thiol upon storage even under cold storage and nitrogen protection.

### Example 3

A solution of 19.45 grams N,N-dimethyl acrylamide, 30.00 grams of 2-acrylamido-2-methylpropanesulfonic acid sodium salt, in 199.88 grams of water was added to a one-liter reactor and was sparged with nitrogen for 1 hour at 75° C. At this time, 3.77 grams of the thiol-bearing polyacrylic acid from Example 1, was charged to the reactor allowing the temperature to rise to about 90° C. to 95° C. After the polyacrylic acid was charged to the reactor, 4.23 grams of 10% sodium hydroxide was added to clear the reaction mixture and then 0.209 grams of Wako™ V-50 (initiator) in 21 grams of water was added to the solution over 90 minutes while maintaining the temperature at about 90° C. to 95° C. After all of the Wako™ V-50 was charged to the reactor, a temperature of 90° C. to 95° C. was maintained until the thiol was non-detectable with Ellman assay. At this time, the reaction mixture was allowed to cool to a temperature of from about 60° C. to 70° C. at which time 0.2 grams of sodium bisulfite in 2.0 grams of water was charged to the reaction mixture followed by 0.1 grams of 70% tert-butyl peroxide in 2 grams water. The contents of the reactor were maintained at a temperature of between about 60° C. to 70° C. for 1 hour and then cooled to room temperature. At this time, 0.51 grams of sodium bisulfite in 2 milliliters (ml) of water was added to eliminate any residual monomers. The sample had a bulk viscosity of 2300 cP and solid content of 20 wt. %. GPC molecular weight (Mw) at 268,000 and Mn 34,500 and no polyacrylic acid block was detected.

### Example 4

In this example, 80.92 grams of 50% acrylamide, 13.50 grams 2-acrylamido-2-methylpropanesulfonic acid sodium salt, in 199.84 grams water were charged into a one-liter reactor equipped with stirrer, thermal couple and nitrogen insert. The content was purged with nitrogen for 1 hour and heated to 75° C. Next, 8.62 grams of the polyacrylic acid from Example 1, was charged to the reactor followed by feeding 0.20 grams sodium persulfate in 20 ml water to the reactor over 90 minutes. The reaction temperature was allowed to increase and then kept between about 90° C. to 95° C. 6.16 grams of 10% sodium hydroxide was added to the reaction mixture after the polyacrylic acid to clear a haziness that developed. After the addition of the persulfate, the mixture (used interchangeably with batch) was reacted for an additional 30 minutes until no thiols were detected by the Ellman assay. The batch was cooled to between about 60° C. to 70° C., sodium bisulfite 0.2 grams in 1 ml of water was added to the reactor, followed by 0.1 grams tert-butyl peroxide (70% 0.1 grams tert-butyl peroxide in 2 ml water). The batch was kept at between about 60° C. to 70° C. for 1 hour and then cooled to room temperature. Sodium bisulfite 0.5 grams in 2 ml water was charged to the reactor to eliminate any residual monomers. The sample had a bulk viscosity of 7670 cP and solid content of 17%. GPC molecular weight Mw at 372,000 and Mn 47,500 and no polyacrylic acid block was detected.

### Example 5

In this example, 80.99 grams of 50% acrylamide, 13.51 grams of 2-acrylamido-2-methylpropanesulfonic acid sodium salt, and 199.86 grams water, were charged into a one-liter reactor equipped with stirrer, thermal couple and nitrogen insert. The contents were purged with nitrogen for 1 hour and then heated to 75° C., at which time 13.76 grams of the polyacrylic acid from Example 2, was charged to the reactor followed by feeding 0.10 grams sodium persulfate in 10 ml water over 90 minutes. The reaction temperature was allowed to increase and then was maintained at about 90° C. to 95° C. After addition of the polyacrylic acid, 6.4 grams of 10% sodium hydroxide was added to the reaction mixture to clear a haziness that developed. After the addition of the persulfate, the mixture was reacted for an additional 30 minutes until no thiols were detected by the Ellman assay. The batch was cooled to between about 60° C. to 70° C., sodium bisulfite 0.2 grams in 1 ml of water was added to the reactor, followed by 0.1 grams tert-butyl peroxide (70% 0.1 grams tert-butyl peroxide in 2 ml water). The batch was kept at between about 60° C. to 70° C. for 1 hour and then cooled to room temperature. 0.5 grams sodium bisulfite in 2 ml water was charged to the reactor to eliminate any residual monomers. The sample had a bulk viscosity of 7100 cP and solid content of 18.4 wt. %. GPC molecular weight (Mw) at 289,000 and Mn 50,500 and no polyacrylic acid block was detected.

### Example 6

In this example, a thiol-bearing telechelic polyacrylic acid from Multhiol Y-4 was prepared. A solution of 49.96 grams ethanol, 60.04 grams water, and 85.07 grams glacier acrylic acid were put into a one-liter reactor having a mechanical stirrer, nitrogen inlet and thermal couple. The contents were purged for 1 hour and heated to 55° C., at which time 7.99 grams 6,6-bis(5′-mercapto-2′-oxo)-4,8-di-oxo-undecane-1,11-dithiol, (also known as Multhiol™ Y-4, SC Organic Chemical Ltd, Japan) in 9.41 grams ethanol was charged to the reactor, followed by Wako V-50 0.08 grams in 4 ml ethanol was charged to the reactor. Polymerization temperature was kept at 50-55° C. with cooling. Polymerization reaction was monitored by checking the solid content with moisture balance at 120° C. until constant weight as well as by assaying thiol concentration with Ellman's method. The polymerization was terminated when 43% of thiol was left and acrylic acid reached a conversion of 99%. The sample could be stored in fridge in a sealed container under nitrogen for about 3 days to minimize further consumption of thiols if not immediately used.

### Example 7

In this example, 80.85 grams of 50% acrylamide, 13.51 grams of 2-Acrylamido-2-methylpropanesulfonic acid sodium salt, and 200.0 grams water, were charged into a one-liter reactor equipped with stirrer, thermal couple and nitrogen insert. The contents were purged with nitrogen for 1 hour and heated to 75° C. At this time, 12.4 grams of the polyacrylic acid from Example 6, was charged to the reactor followed by feeding 0.10 grams sodium persulfate in 10 ml water to the reaction mixture over 90 minutes. The reaction temperature was allowed to increase and then controlled at from about 90° C. to 95° C. After addition of the persulfate was finished, the batch was continued for 30 minutes at which time no thiols were detected by Ellman assay. The batch was cooled to between 60° C. to 70° C. 0.2 grams of sodium bisulfite in 1 ml of water was charged to the reactor, followed by 0.1 grams of tert-butyl peroxide (70% 0.1 grams in 2 ml water). The batch was maintained at from about 60° C. to about 70° C. for 1 hour and then cooled to room temperature at which time 0.5 grams of sodium bisulfite in 2 ml water was charged to the reactor to eliminate any residual monomers. The sample had a bulk viscosity of 16640 centipoise (cP) and solid content of 18.9 wt. %. The GPC molecular weight (Mw) was 376,000 and Mn 45,300 and non-reacted polyacrylic acid block was detected as a shoulder peak at very small amount.

### Example 8

In this example, 393.2 g, of 50% acrylamide, 66.79 grams of 2-acrylamido-2-methylpropanesulfonic acid sodium salt, 0.60 grams Verenex™ 80, and 93.79 grams water, were charged into a one-liter reactor with mechanical stirrer, thermal couple, and nitrogen inlet. The contents of the reactor were purged with nitrogen for 1 hour and then cooled to about minus 15° C. with dry ice in ethanol. During cooling, 31.56 grams polyacrylic acid from Example 1, and 0.21 grams Wako™ V-50 were charged to the reactor. The contents were irradiated under a mercury UV lamp and polymerization was conducted with air cooling and a temperature around 110° C. was reached, and the contents were allowed to cool to 65° C. A gel was obtained that was sprayed with 36 grams of 6.4% aminoethylethanolamine and mixed with 12.8 grams sodium bicarbonate and 20 grams starch in a meat grinder. The finished polymer gel mixture was found to have a solid content of 53%. The gel was molded into a thin film by placing 15 grams of the gel between two non-sticky cook sheets of 12×12 inches and pressed under hydraulic press at 150° F. and 10,000 pound force. The film from the press was then coated with 2.5 grams corn starch to prevent the films from sticking to other pressed films. The coated film was then broken into smaller flakes and dried at 90° C. oven for 20 minutes and ground and sieved through #40 mesh sieve to form micro-plates having a thickness of about 150 microns.

### Example 9

This is a comparative example with Example 2, in which random star polymers were obtained. In this example, 19.82 grams dimethylacrylamide, 30.01 grams 2-acrylamido-2-methylpropanesulfonic acid sodium salt, 1.35 grams acrylic acid, and 199.67 grams water, were combined in a one-liter reactor as described above, and the pH of the mixture was adjusted to 5.1 and 0.31 grams of Gebepro™ GPM-800 was charged to the reactor instead of the thiol terminated polyacrylic acid of Example 2. The mixture was degassed, and the same polymerization process of Example 2 was followed.

### Example 10

This is a comparative example with Example 3, in which a random star polymer was obtained. In this example, 80.94 grams of 50% acrylamide, 13.50 grams of 2-acrylamido-2-methylpropanesulfonic acid, sodium salt, 2.89 grams of acrylic acid, and 194.58 grams of water were added to a 1-liter reactor as described above and the contents were mixed. The pH was adjusted using 11.6 grams of 10% sodium hydroxide until a pH of 5.1 was reached and 0.63 grams of Gebepro™ GPM-800 was charged to the reactor instead of the thiol terminated polyacrylic acid used in Example 3. After the contents of the reactor were degassed, the same polymerization process of Example 3 was followed.

### Example 11

In this example, the test method according to ASTM C1506-09 was used to estimate the water retention of a cement admix with water at a weight ratio of 4.92. Quikrete Profinish Blended Mason Mix was mixed with 0.2% BioDrill RC104 of calcium lignin sulfonate as a retarder, 0.4% Tamol SN of polynaphthalene sulfonate as dispersant. The example polymers and commercial product were tested at 0.2% active. All percentage are based on the weight of the admix. The vacuum filtration was done at room temperature and 50 Torr for 15 minutes after the mortar slurry was made. The percentage of water retention obtained can be found in Table 1.

TABLE 1
Percent Water Retention of Cement Admix with Water

| Example # | % Water Retention |
|---|---|
| No Water retention | 35.4 |
| Example 3 | 89.7 |
| Example 4 | 90.1 |
| Example 5 | 87.3 |
| Example 8 | 91.5 |
| Example 9 (Comp to Ex. 2) | 54.0 |
| Example 10 (Comp to Ex. 3/4) | 78.5 |
| Commercial Product | 80.1 |

### Example 12

In this example, test method ASTM C1506-09 was used to estimate the water retention of a Type I/II Portland cement with water at weight ratio of 3.73. Quikrete Portland cement was mixed with 0.3% retarder (BioDrill™ RC104, calcium lignin sulfonate), 0.6% dispersant (Tamol SN, polynaphthalene sulfonate). The polymer synthesized in the above examples was added at 0.5% active based on cement against a known commercial product. The vacuum filtration was done at room temperature, 50 Torr for 15 minutes after the mortar slurry was made. Table 2 shows the results of the evaluation results.

TABLE 2
Water Retention of Type I/II Portland Cement

| Example # | % Water Retention |
|---|---|
| No Water retention | 60.2 |
| Example 3 | 93.6 |
| Example 4 | 93.1 |
| Example 5 | 92.5 |
| Example 7 | 94.1 |
| Example 8 | 95.0 |
| Commercial Product | 88.3 |

Results indicate that the μ-star polymer of Examples 3 to 5 and 7-8, containing a polyacrylic acid arm, was observed to retain the most water within the admix. Although the commercial product performed well, it had an undesirable effect of thickening the cement slurry.

### Example 13

The dispersing power of the μ-star block copolymer based on either acrylamide (AM) or dimethylacrylamide (DMA) was evaluated against commercial product Floset™ OF 5510 by using the mini slump test (DIN EN 1015) for dispersing efficacy. The mini slump test is described in Ilg, M and Plank, J; Ind. Eng. Chem. Res. 58 (2019), 12913-12926, and was conducted as follows: The polymer if it is an aqueous solution was either added to water or blended with cement if the polymer is a powder at a specific dosage based on the amount of cement. The water content of the polymer solution was subtracted from the total amount of mixing water to perform all experiments at the same w/c ratio. As such, 300 grams of cement was added over 1 minute to the mixing water, soaked for 1 minute, and subsequently agitated manually for 2 minutes with a spoon. Next, the cement slurry was transferred into a Vicat cone (height of 40 millimeter (mm), top diameter of 70 mm, bottom diameter of 80 mm) placed on a glass plate and filled to the brim. The cone was immediately lifted upward and kept for 5 seconds over the spreading cement paste. The diameter of the cement slurry was measured twice with a caliper, the first measurement being perpendicular to the second one, and averaged to obtain the spread flow value. The mini slump tests were carried out at room temperature. The water-to-cement ratio (w/c) of the neat cement paste was established with no dispersing additive added. The dosage (% weight on dry cement) and water to cement ratio is listed in Table 3 along with testing results.

TABLE 3
Dispersing Efficacy by Mini Slump Test

| Polymer or Blank | | | | | | |
|---|---|---|---|---|---|---|
| | Neutral | % | W/C | Spread | % Active | % Water |
| Polymer | Monomer | Active | ratio | cm | Dose | Reduction |
| Blank | — | — | 0.50 | 13 | 0.00 | — |
| Example 5 | AM | 18.39 | 0.50 | 18 | 0.10 | — |
| Example 5 | AM | 18.39 | 0.50 | 25 | 0.25 | — |
| Example 5 | AM | 18.39 | 0.50 | 28 | 0.50 | — |
| Floset OF | AM | 100 | 0.50 | 8 | 0.25 | — |
| 5510 | | | | | | |
| Example 7 | AM | 18.91 | 0.50 | 25 | 0.25 | — |
| Example 5 | AM | 18.39 | 0.50 | 25 | 0.25 | — |
| Example 8 | AM | 85.4 | 0.50 | 21 | 0.25 | — |
| Example 3 | DMA | 19.87 | 0.50 | 27 | 0.25 | — |
| Example 3 | DMA | 19.87 | 0.37 | 8 | 0.25 | — |
| Example 3 | DMA | 19.87 | 0.37 | 19 | 0.50 | 26 |
| Example 3 | DMA | 19.87 | 0.35 | 16 | 0.50 | 29 |

The dispersing property imparted by the μ-star block co-polymer of lower molecular weights is advantageous over random co-polymer, e.g., Floset™ OF 5510 used as water-retention/fluid loss control agent. The buoyant long chain(s) provided by sulfonated polymer segments keeps water only inside the cement particles while reducing the interstitial water.

What is claimed is:

1. A miktoarm star polymer comprising: one or more distinct polymer chain(s) bearing one or more of a functional monomeric unit chosen from carboxylic acid, phosphate acid ester, and phosphonate; one or more hydrophilic polymer chain(s) bearing one or more of the functional monomeric unit chosen from sulfonate and sulfate, and combinations thereof.

2. The miktoarm star polymer according to claim 1, wherein the one or more distinct polymer chain(s) and one or more hydrophilic polymer chain(s) form a star polymer diverging from a moiety bearing polyfunctional radical transfer functions chosen from thiol or mercaptan functional groups, phosphinic acid, phosphites, and combinations thereof.

3. The miktoarm star polymer according to claim 1, further comprising additional monomeric units different from the monomers of the distinct polymer chain(s) and the hydrophilic polymer chain(s).

4. The miktoarm star polymer according to claim 1, wherein the one or more distinct polymer chain(s) and the one or more hydrophilic polymer chain(s) are derived from polythiols bearing three or more thiol or mercaptan functional groups.

5. The miktoarm star according to claim 1, wherein the polyfunctional radical transfer group is chosen from thiol or mercaptan functional groups, or a combination thereof, and wherein one or more of the thiols or mercaptan functional groups is attached to one or more of the one or more distinct polymers either through stepwise radical transfer polymerization or direct chemical reaction with thiol-bearing substances and the rest of the thiol functional groups from the one or more distinct polymer(s) act as chain transfer agents to grow the hydrophilic polymer chain(s), thus forming the miktoarm star copolymer.

6. The miktoarm star polymer according to claim 1, wherein one or more of the one or more distinct polymer chain(s) comprises polyacrylic acid arm(s) having a weight average molecular weight of from about 1000 to about 50000 Daltons and the one or more of the hydrophilic polymer chain(s) comprises sulfonated or sulfated arm(s) having a weight average molecular weight of from about 10000 to about 1,000,000 Daltons.

7. The miktoarm star polymer according to claim 1, wherein one or more of the hydrophilic polymer chain(s)s comprises one sulfonic acid-containing monomer or its salt alone or with one or more other monomer.

8. The miktoarm star polymer according to claim 7, wherein the sulfonic acid-containing monomer is chosen from 2-acrylamido-2-methylpropanesulfonic acid, vinylsulfonic acid, methallyl sulfonic acid, allylhydroxypropanesulfoinic acid, or the salts thereof, styrene sulfonate, or allyl polyoxyethylene sulfate ester salt.

9. The miktoarm star polymer according to claim 2, wherein the additional monomeric unit is derived from acrylamide, methyacrylamide, N,N-dimethyl(meth)acrylamide, N—N-diethyl(meth)acrylamide, or isopropyl(meth)acrylamide; N-tert-butylacrylamide, or amides of α, β-ethylenically unsaturated mono- or dicarboxylic acids with diamines having one or more primary or secondary amine group; N,N-diallylamines, or N,N-diallyl-N-alkylamines; esters of α, β-ethylenically unsaturated mono- or dicarboxylic acids with C₂₋₃₀ alkanediols or their alkoxylates; tetrahydrofurfuryl acrylate; N-vinylcaprolactam, N-vinylpyrolidone, N-vinylacetamide, N-vinylformamide, N-methyl-N-vinylacetamide, N-vinylpiperidone, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, N-vinyl-7-ethyl-2-caprolactam, vinylpyridine, α, β-ethylenically unsaturated ethers of C₂₋₃₀ alkanediols or their alkoxylates, or combinations thereof.

10. A process of producing a miktoarm star polymer comprising:
a) preparing a thiol-bearing telechelic polymer chain by polymerizing a composition comprising monomers bearing carboxylic acids, phosphate acid esters, phosphonates, and combinations thereof; a polythiol or mercaptan-bearing moiety and a radical initiator;
b) preparing a monomer solution comprising one or more monomer(s) bearing sulfonate or sulfate functional groups to form one or more hydrophilic polymer chain(s) or segment(s);
c) combining the thiol-bearing telechelic polymer chain from step a) with the monomer solution containing one or more functional monomers bearing sulfonate or sulfate of step b) and initiating polymerization with radical initiator(s);
d) continuing the polymerization reaction until the thiol concentration is non-detectable by using Ellman assay techniques thereby producing a miktoarm star polymer diverging from a moiety bearing polyfunctional radical transfer functions chosen from thiol or mercaptan functional groups, phosphinic acid, phosphites, and combinations thereof.

11. The process according to claim 10, further comprising additional monomeric units different from those in the thiol-bearing telechelic polymer chain(s) and the hydrophilic polymer chain(s), wherein the additional monomer units bears functions other than those in the thiol-bearing telechelic polymer chain(s) and the hydrophilic polymer chain(s).

12. The process according to claim 10, wherein the polyfunctional radical transfer function is chosen from thiol or mercaptan functional groups, or a combination thereof, and wherein one or more of the thiols or mercaptan functional groups is attached to one or more of the one or more distinct polymers either through stepwise radical transfer polymerization or direct chemical reaction with thiol-bearing substances and the rest of the thiol functional groups from the one or more distinct polymer chain(s) act as chain transfer agents to grow the hydrophilic polymer chain(s), thus forming the miktoarm star copolymer.

13. The process according to claim 12, wherein one or more but not all of the thiol or mercaptan functional groups is attached to the one or more distinct polymer chain(s) and the remaining thiol functional groups on the one or more distinct polymer chain(s) act as chain transfer agents to grow the hydrophilic polymer chain(s).

14. The process according to claim 10, wherein the one or more distinct polymer chain(s) comprises a polyacrylic acid arm having a molecular weight of from about 1000 to about 50000 and the one or more hydrophilic polymer chain(s) comprise sulfonated arms having a molecular weight of from about 10000 to about 1,000,000.

15. The process according to claim 10, wherein the hydrophilic polymer chain(s) is chosen from 2-acrylamido-2-methylpropanesulfonic acid, vinylsulfonic acid, methallyl sulfonic acid, allylhydroxypropanesulfoinic acid, or its salts and allyl polyoxyethylene sulfate ester salt alone or with acrylamide, methacrylamide, N,N-dimethyl(meth)acrylamide, N—N-diethyl(meth)acrylamide, isopropyl(meth)acrylamide; N-tert-butylacrylamide, amides of α, β-ethylenically unsaturated mono- or dicarboxylic acids with diamines having one or more primary or secondary amine group; N,N-diallylamines, and N,N-diallyl-N-alkylamines; esters of α, β-ethylenically unsaturated mono- or dicarboxylic acids with C₂₋₃₀ alkanediols or their alkoxylates; and tetrahydrofurfuryl acrylate; N-vinylcaprolactam, N-vinylpyrolidone, N-vinylacetamide, N-vinylformamide, N-methyl-N-vinylacetamide, N-vinylpiperidone, N-vinyl-5-methyl-2-pyrrolidone, N-vinyl-5-ethyl-2-pyrrolidone, N-vinyl-6-methyl-2-piperidone, N-vinyl-6-ethyl-2-piperidone, N-vinyl-7-methyl-2-caprolactam, and N-vinyl-7-ethyl-2-caprolactam, vinylpyridine, and α, β-ethylenically unsaturated ethers of C₂₋₃₀ alkanediols or their alkoxylates.

16. The process according to claim 10, wherein the polymerization reaction is continued until the thiol concentration is non-detectable based on Ellman assay techniques.

17. A method for reducing fluid loss in mortar or concrete processes comprising:
providing a mortar ground or concrete slurry;
adding to the mortar ground or concrete slurry a miktoarm star polymer comprising one or more one or more distinct polymer chain bearing one or more of functional monomeric unit chosen from carboxylic acid, phosphate acid ester, and phosphonate; one or more hydrophilic polymer chain(s) bearing one or more functional monomeric units chosen from sulfonate and sulfate, and combinations thereof.

18. The method according to claim 17, wherein the one or more distinct polymer chain(s) and one or more hydrophilic polymer chain(s) form a star polymer diverging from a moiety bearing polyfunctional radical transfer functions chosen from thiol or mercaptan functional groups, phosphinic acid, phosphites, and combinations thereof.

19. The method according to claim 17, wherein the polyfunctional radical transfer function is chosen from thiol or mercaptan functional groups, or a combination thereof, and wherein one or more of the thiols or mercaptan functional groups is attached to one or more of the one or more distinct polymers either through stepwise radical transfer polymerization or direct chemical reaction with thiol-bearing substances and the rest of the thiol functional groups from the one or more distinct polymer chain(s) act as chain transfer agents to grow the one or more hydrophilic polymer chain(s), thus forming the miktoarm star polymer.

20. The method according to any one of claim 17, wherein the miktoarm star polymer acts as a dispersant or superplasticizer in mortar or concrete processes.
